(19) United States
(12) Patent Application Publication
(10) Pub. No.: US 2025/0309560 A1
(43) Pub. Date: Oct. 2, 2025

(54) SERIES-FED ARRAY SYSTEM FOR SIGNAL TRANSMISSION

(71) Applicant: TRON FUTURE TECH INC., HSINCHU CITY (TW)

(72) Inventors: LI HAN CHANG, HSINCHU CITY (TW); YU-JIU WANG, HSINCHU CITY (TW)

(21) Appl. No.: 18/963,348

(22) Filed: Nov. 27, 2024

Related U.S. Application Data
(60) Provisional application No. 63/572,642, filed on Apr. 1, 2024.

(51) Int. Cl. H01Q 21/00

(52) U.S. Cl. CPC H01Q 21/0006

(57) ABSTRACT

An array system for signal transmission includes a transmission line, N array elements and N capacitors. The transmission line includes N tap points. The N array elements are configured to be driven by N voltage signals fed to N input terminals of the N array elements respectively. Each array element includes a transistor, and N gates of N transistors in the N array elements serves as the N input terminals respectively. The N capacitors are arranged to capacitively couple the N tap points to the N gates of the N transistors, respectively, to provide the N voltage signals. Capacitance of each capacitor is less than input capacitance at a gate of a corresponding transistor coupled to the capacitor.

### PRIORITY CLAIM AND CROSS-REFERENCE

The present application claims priority to U.S. Provisional Patent Applications including Ser. No. 63/572,642, filed on Apr. 1, 2024, which is incorporated by reference herein in its entirety.

### BACKGROUND

The present disclosure relates to signal transmission and, more particularly, to a series-fed array system for signal transmission.

A phased array antenna system is a sophisticated technology utilizing multiple radiating elements that work in unison to steer signal beams electronically. By applying specific phase shifts to each radiating element, the phased array antenna system can dynamically control the beam direction and radiation pattern without the need for physical movement. Phased array antennas are widely used in applications, such as radar, telecommunications and satellite communications, to provide precise, real-time beam control. In phased array antenna systems, power distribution among radiating elements is critical, given that consistent power levels help achieve an optimal radiation pattern and maximum gain in the desired direction. Imbalanced power distribution may result in signal degradation, reduced efficiency and undesired sidelobes, hightlighting the importance of careful power management in phased array design.

### SUMMARY

The described embodiments provide a series-fed array system for signal transmission.

Some embodiments described herein may include an array system for signal transmission. The array system includes a transmission line, N array elements and N capacitors. The transmission line includes N tap points. The N array elements are configured to be driven by N voltage signals fed to N input terminals of the N array elements respectively. Each array element includes a transistor, and N gates of N transistors in the N array elements serves as the N input terminals respectively. The N capacitors are arranged to capacitively couple the N tap points to the N gates of the N transistors, respectively, to provide the N voltage signals. Capacitance of each capacitor is less than input capacitance at a gate of a corresponding transistor coupled to the capacitor.

Some embodiments described herein may include an array system for signal transmission. The array system includes a transmission line, N array elements and N capacitors. The transmission line includes N tap points. The N array elements are configured to be driven by N voltage signals fed to N input terminals of the N array elements respectively. Each array element includes a radiating element and an integrated circuit. The integrated circuit, coupled to the radiating element, is being configured to be driven by a corresponding voltage signal to enable the radiating element to emit a radio frequency signal. A gate of a transistor in the integrated circuit serves as the input terminal of the array element. The N capacitors have N first terminals respectively coupled to the N tap points, and N second terminals respectively coupled to the N input terminals. The N capacitor are arranged to provide the N voltage signals.

With the use a capacitor disposed in the feed path between the tap point of the transmission line and the high-input-impedance array element, the proposed series-fed array system can reduce or eliminate the effect of temperature or environmental variations on the input capacitance of the array element, achieving effective impedance matching design and high-quality signal transmission.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating an exemplary array system in accordance with some embodiments of the present disclosure.

FIG. 2 is a diagram illustrating the architecture for extracting the return loss and the insertion loss associated with each array element shown in FIG. 1 in accordance with some embodiments of the present disclosure.

FIG. 3 is a diagram illustrating an exemplary array system in accordance with some embodiments of the present disclosure.

FIG. 4 illustrate architecture for extracting the return loss and the insertion loss associated with each array element shown in FIG. 3 in accordance with some embodiments of the present disclosure.

FIG. 5A illustrates frequency responses of the return loss under different capacitance values of the capacitor in the architecture shown in FIG. 4 in accordance with some embodiments of the present disclosure.

FIG. 5B illustrates frequency responses of the insertion loss under different capacitance values of the capacitor in the architecture shown in FIG. 4 in accordance with some embodiments of the present disclosure.

FIG. 6 is a diagram illustrating architecture for extracting the characteristics of the return loss and the insertion loss of the transmission line shown in FIG. 3 in accordance with some embodiments of the present disclosure.

FIG. 7A illustrates frequency responses of the insertion loss for the eight-array-element series-fed system shown in FIG. 6 in accordance with some embodiments of the present disclosure.

FIG. 7B illustrates frequency responses of the return loss for the eight-array-element series-fed system shown in FIG. 6 in accordance with some embodiments of the present disclosure.

FIG. 8A illustrates the frequency response of the insertion loss in a configuration where the tap points in FIG. 6 are directly connected to the input terminals, respectively, in accordance with some embodiments of the present disclosure.

FIG. 8B illustrates the frequency response of the return loss in a configuration where the tap points in FIG. 6 are directly connected to the input terminals, respectively, in accordance with some embodiments of the present disclosure.

FIG. 9 is a diagram illustrating an implementation of the capacitor in the high-impedance feed path shown in FIG. 3 in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the present disclosure may repeat reference numerals and/or letters in the various examples. This repetition is for the purpose of simplicity and clarity and does not in itself dictate a relationship between the various embodiments and/or configurations discussed.

Further, it will be understood that when an element is referred to as being “connected to” or “coupled to” another element, it may be directly connected to or coupled to the other element, or intervening elements may be present.

Moreover, spatially relative terms, such as “below,” “above,” “left,” “right,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

An antenna array system may employ a tree-structured power distribution method to transmit input power layer by layer to each antenna element within the antenna array system. However, when the input power fluctuates, the power received by each antenna element also changes accordingly.

The present disclosure describes exemplary array systems for signal transmission, each of which utilizes series-fed power distribution architecture including high-impedance elements. A voltage signal can be fed to an array element through a corresponding high-impedance path. The exemplary array system may be implemented as an antenna array system, a switch array system, or other array systems having high-impedance elements. The exemplary array system not only can reduce power/signal distribution loss, but also can improve system stability. Further description is provided below.

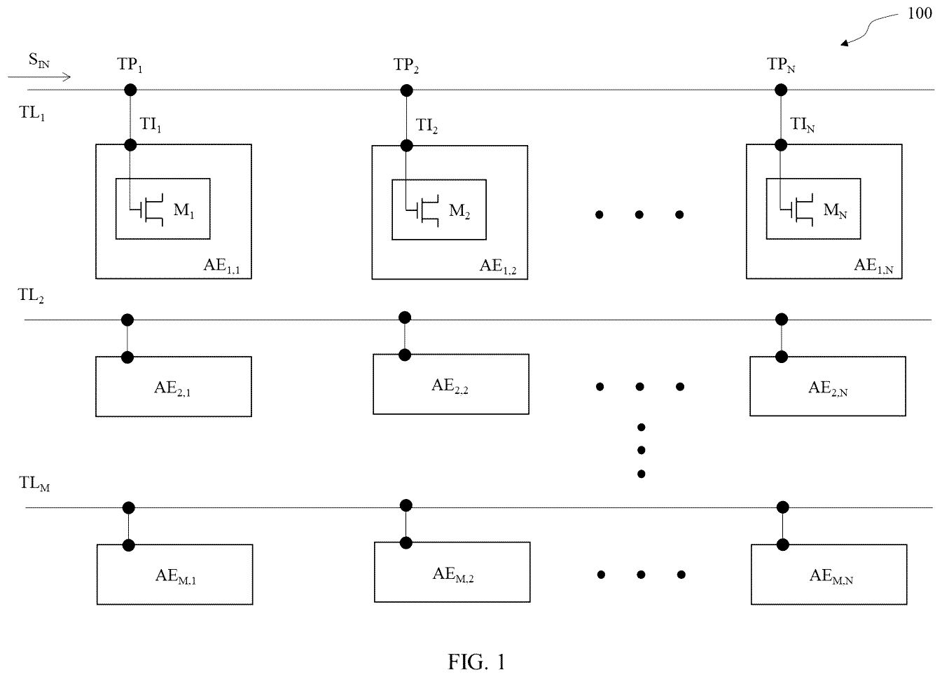

FIG. 1 is a diagram illustrating an exemplary array system in accordance with some embodiments of the present disclosure. The array system 100 may include, but is not limited to, one or more transmission lines TL₁ to TL_{M} (where M is a positive integer) and a plurality of array elements AE_{1,1} to AE_{M,N} (where N is an integer greater than one). The array system 100 utilizes series-fed architecture to distribute energy, transmitted by the transmission line TLᵢ, to the array elements AE_{i,1} to AE_{i,N} through multiple tap points of the transmission line TLᵢ, and accordingly drive the array elements AE_{i,1} to AE_{i,N}, where i=1, 2, . . . , M. Each array element can be driven by a voltage signal fed to an input terminal thereof. For example, the transmission line TL₁ used for transmitting an input signal S_{IN} may include a plurality of tap points TP₁ to TP_{N}, at which energy of the input signal S_{IN} can be accessed or obtained. The array elements AE_{1,1} to AE_{1,N} can be driven by voltage signals that are fed from the tap points TP₁ to TP_{N} to the input terminals TI₁ to TI_{N}.

Each array element may be an element with high input impedance, such that respective voltage magnitudes at tap points along the same transmission line can are equal or substantially equal. For example, the characteristic impedance of the transmission line TL₁ may be much lower than the input impedance of each of the array elements AE_{1,1} to AE_{1,N}, resulting in equal or substantially equal voltage magnitudes at the tap points TP₁ to TP_{N}. In the present embodiment, each array element may include a transistor, and a gate of the transistor can serve as the input terminal of the array element to achieve high input impedance. For example, respective gates of the transistors M₁ to M_{N} can serve as the input terminals TI₁ to TI_{N} of the array elements AE_{1,1} to AE_{1,N}, respectively.

The array system 100 may be implemented as, but not limited to, an antenna array system, a switch array system, or other array systems having high-impedance elements. By way of example but not limitation, each array element may be an antenna element that includes, but is not limited to, an integrated circuit and a radiating element. A gate of a transistor in the integrated circuit, arranged for receiving a voltage signal from a tap point, can serve as an input terminal of the array element. As another example, each array element may include an amplifier such as a power amplifier. A gate of a transistor in the amplifier, arranged for receiving a voltage signal from a tap point, can serve as an input terminal of the array element. As still another example, each array element may include a switch element. A gate of a transistor in the switch element, arranged to receive a voltage signal from a tap point, can serve as an input terminal of the array element.

The array system 100 (also referred to as a series-fed power distribution system with high-impedance elements) can achieve impedance matching design by unifying respective inductance-capacitance (LC) products of the array elements, rather than employing an impedance element that matches characteristic impedance of the transmission line. The array system 100 can control the LC product to be maintained at a predetermined value or within a predetermined range, and set a resonant frequency corresponding to the square root of the LC product to be significantly higher than a maximum frequency within an operating frequency band, thereby reducing the influence of resonance on the desired frequency range and improving the characteristics of the return loss (S11) and the insertion loss (S21).

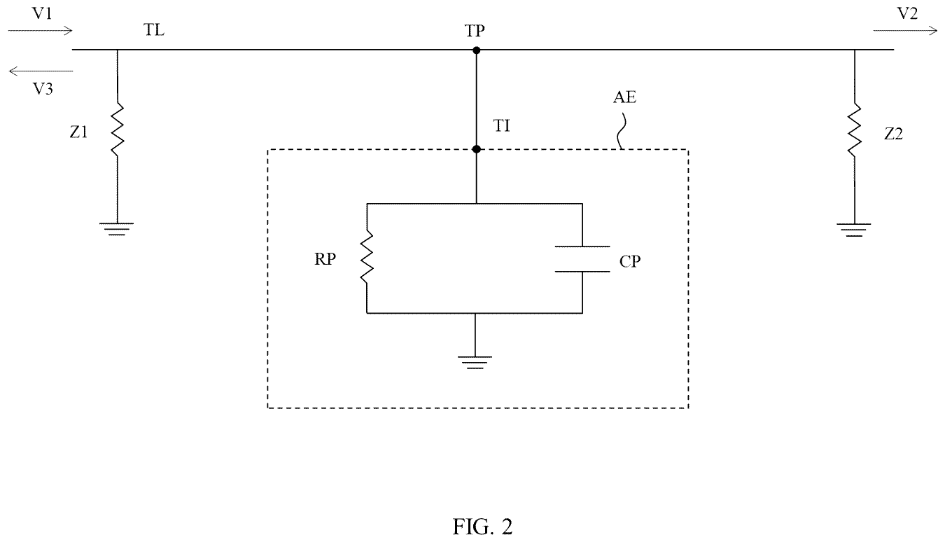

FIG. 2 is a diagram illustrating the architecture for extracting the return loss (or the reflection coefficient) and the insertion loss associated with each array element shown in FIG. 1 in accordance with some embodiments of the present disclosure. The array element AE shown in FIG. 2 can represent one of the array elements AE_{1,1} to AE_{M,N} shown in FIG. 1. In the present embodiment, an input end and an output end of the transmission line TL are connected to the impedance elements Z1 and Z2 respectively, in which an impedance value of the impedance element Z1/Z2 matches the characteristic impedance of the transmission line TL. The return loss can be extracted based on the voltage signal V1 (inputted to the input end) and the voltage signal V3 (reflected back from the input end), and the insertion loss can be extracted based on the voltage signal V1 and the voltage signal V2 (outputted from the output end).

In addition, the tap point TP of transmission line TL is coupled to the input terminal TI of the array element AE. The equivalent circuit viewed from the input terminal TI (i.e. a gate of a transistor included in the array element AE) can be represented by the resistor RP and the capacitor CP connected in parallel. The resistance of the resistor RP may be much larger than the characteristic impedance of the transmission line TL. By way of example but not limitation, the resistance of the resistor RP may exceed 1000 ohms, while the characteristic impedance of the transmission line TL may be 50 ohms. However, due to temperature variations, process variations, and/or doping concentration, the parasitic effects of active elements are difficult to control, leading to instability in the capacitance of the capacitor CP. In other words, there are considerable variations in equivalent capacitance across different array elements, resulting in notable differences in LC product of individual array elements and degraded return loss and insertion loss characteristics for the overall system.

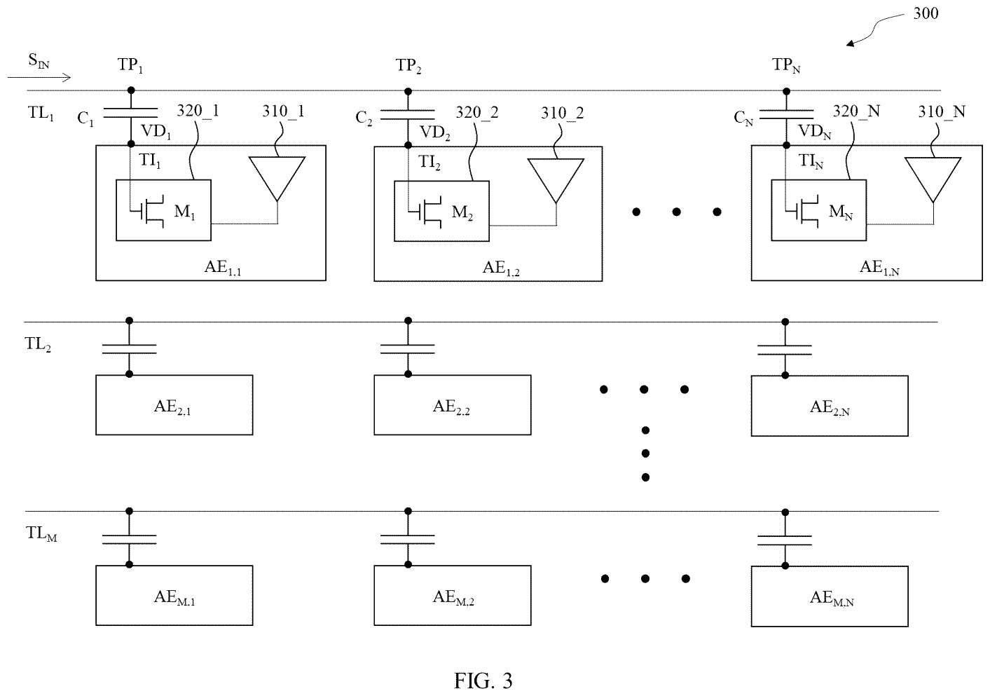

FIG. 3 is a diagram illustrating an exemplary array system in accordance with some embodiments of the present disclosure. The structure of the array system 300 is substantially identical/similar to that of the array system 100 shown in FIG. 1 except for the capacitors, each of which is disposed between a tap point and an array element. In the present embodiment, the array system 300 can be implemented as a phased array antenna system. Each array element can be implemented as an antenna element, which may include, but is not limited to, an integrated circuit (or a chip) and a radiating element. For example, the array element AE_{1,i} may include a radiating element 310_i and an integrated circuit 320_i, where i=1, 2, . . . , N. The integrated circuit 320_i, coupled to the radiating element 310_i, is configured to be driven by a corresponding voltage signal to thereby enable the radiating element 310_i to emit a radio frequency signal. The integrated circuit 320_i includes a transistor Mᵢ, a gate of which can serve as the input terminal TIᵢ. However, this is not intended to limit the scope of the present disclosure. Each array element may be implemented using other high-input-impedance elements without departing from the scope of the present disclosure.

The array system 300 may further include a plurality of capacitors, each of which is disposed in a feed path between a tap point and an array element. For example, the capacitor C₁ may be disposed between the tap point TP₁ and the input terminal TI₁ (or the gate of transistor M₁), the capacitor C₂ may be disposed between the tap point TP₂ and the input terminal TI₂ (or the gate of transistor M₂), and so on. In other words, first terminals of the capacitors C₁ to C_{N} are coupled to the tap points TP₁ to TP_{N}, respectively, and second terminals of the capacitors C₁ to CN are coupled to the input terminals TI₁ to TI_{N}. In addition, each capacitor is arranged to capacitively couple a tap point to a corresponding input terminal to provide a voltage signal (e.g. one of the voltage signals VD₁ to VD_{N}) fed to the input terminal, thereby driving a corresponding array element.

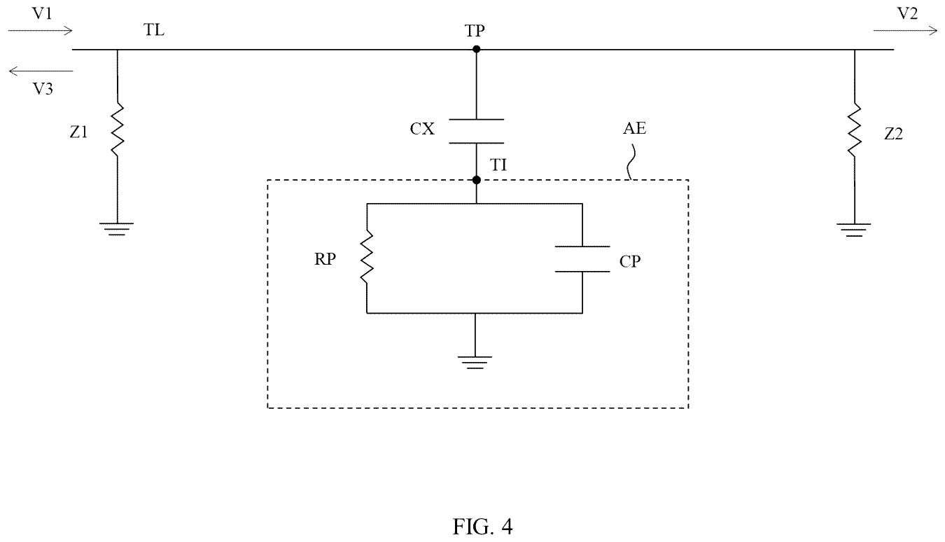

The capacitor placed between the tap point and the gate of the transistor can reduce or eliminate the influence of variations in input capacitance at the gate on impedance matching. Referring to FIG. 4, architecture for extracting the return loss (or the reflection loss) and the insertion loss associated with each array element shown in FIG. 3 is illustrated in accordance with some embodiments of the present disclosure. The architecture shown in FIG. 4 is identical/similar to that shown in FIG. 2 except for the capacitor CX that is connected between the tap point TP and the input terminal TI (or a transistor's gate). In the present embodiment, the capacitor CX (e.g. one of the capacitors C₁ to C_{N} shown in FIG. 3) can be a thin-film capacitor or another type of capacitor with stable capacitance. Connecting the capacitor CX between the tap point TP and the input terminal TI can reduce variations in equivalent capacitance viewed from the tap point TP, thereby improving the consistency of the LC products across different array elements.

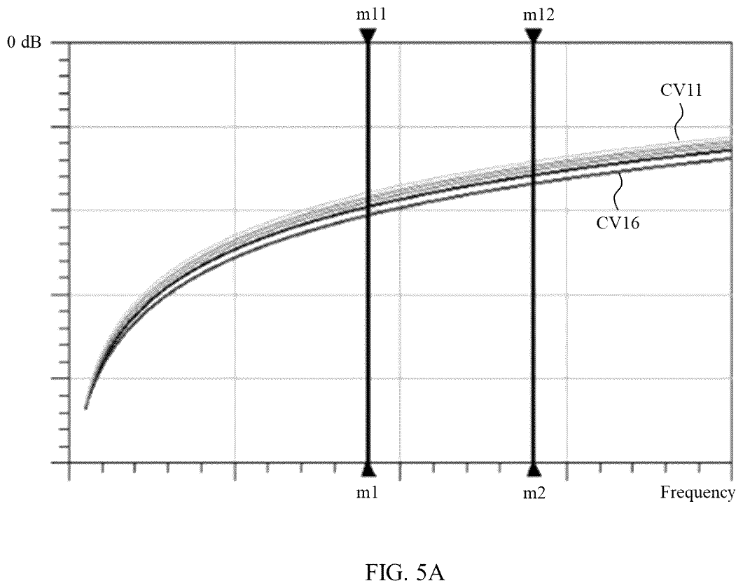

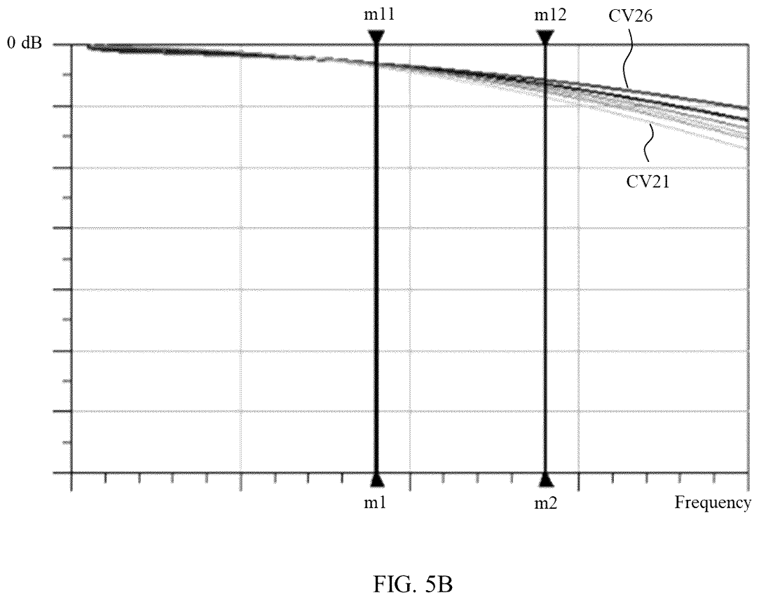

FIG. 5A illustrates frequency responses of the return loss (S11) under different capacitance values of the capacitor CP in the architecture shown in FIG. 4 in accordance with some embodiments of the present disclosure. Referring to FIG. 5A, in the present embodiment, curves CV11 to CV16 illustrate the frequency responses of the return loss obtained when the capacitance of the capacitor CP is varied across the capacitance values f1 to f6 (i.e. different input capacitance values at a transistor's gate), while the capacitor CX remains at a capacitance value f0. The capacitance values f1 to f6 increase progressively (e.g. from 100 fF to 500 fF) to represent the potential variation range of the capacitor CP. In addition, the capacitance value f0 is smaller than each of the capacitance values f1 to f6. By way of example but not limitation, the capacitance value f0 may be set to less than one-fifth of the capacitance value of the capacitor CP. As shown in FIG. 5A, variations in the capacitance value of the capacitor CP have a minor effect on the frequency response of the return loss (corresponding to the characteristics of the reflection coefficient), indicating that the capacitor CX effectively stabilizes the equivalent capacitance viewed from the tap point TP. Furthermore, higher capacitance values of the capacitor CP can yield better frequency response characteristics, meaning that the smaller the capacitance value of the capacitor CX relative to the capacitance value of the capacitor CP, the better the signal transmission quality. In some embodiments, when the capacitance of the capacitor CX is much smaller than that of the capacitor CP, the influence of the capacitance variation of the capacitor CP on impedance matching can be eliminated or substantially eliminated.

FIG. 5B illustrates frequency responses of the insertion loss (S21) under different capacitance values of the capacitor CP in the architecture shown in FIG. 4 in accordance with some embodiments of the present disclosure. Referring to FIG. 5B, curves CV21 to CV26 illustrate the frequency responses of the insertion loss obtained when the capacitance of the capacitor CP is varied across the capacitance values f1 to f6 (i.e. different input capacitance values at a transistor's gate), while the capacitor CX remains at the capacitance value f0. As shown in FIG. 5B, the addition of the capacitor CX can reduce the impact of the capacitance variation of the capacitor CP on the frequency response of the insertion loss; the capacitor CX having a capacitance value smaller than a capacitance value of the capacitor CP can enhance signal transmission quality.

Referring again to FIG. 3, each array element included in the array system 300 can be a high-input-impedance element. Thus, respective voltage magnitudes at adjacent tap points on the same transmission line are equal or substantially equal. For example, the input impedance viewed from each tap point toward the corresponding capacitor is greater than, or much greater than, the characteristic impedance of the transmission line. As another example, the input impedance viewed from the input terminal toward the array element (i.e., the input impedance of the array element) is greater than, or much greater than, the characteristic impedance of the transmission line. Compared to a series-fed power distribution system that utilizes impedance matching between input impedance and transmission line impedance, the array system 300 employing high-impedance array elements can achieve impedance matching by unifying respective LC products of the array elements, rather than using a transistor's drain as an input terminal of the array element or using an LC matching network. In other words, impedance matching can be achieved by designing a product of equivalent inductance and equivalent capacitance at each tap point to be uniform or nearly uniform across multiple tap points.

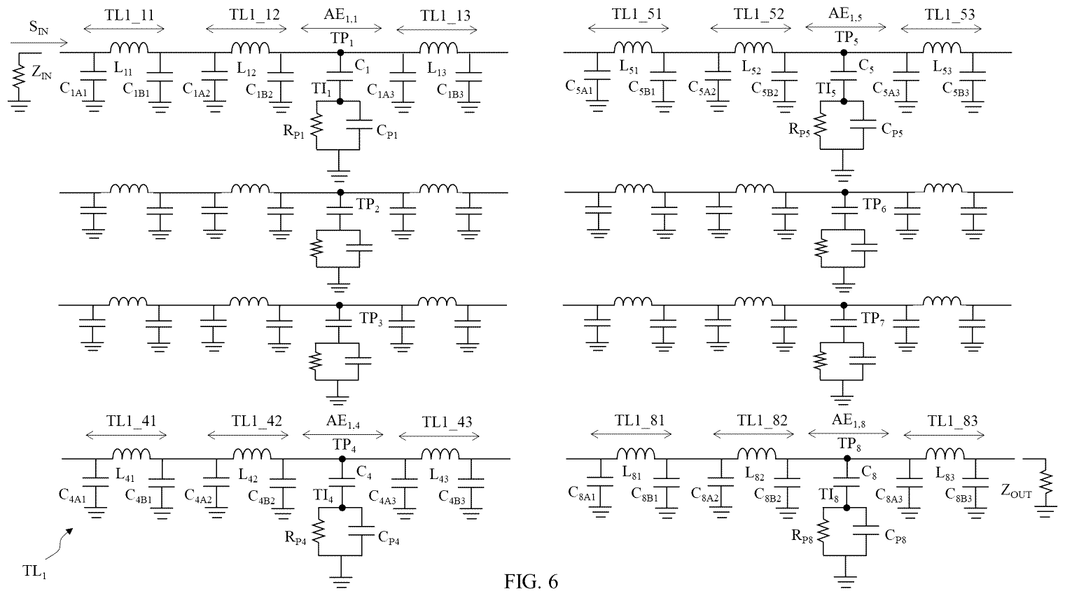

FIG. 6 is a diagram illustrating architecture for extracting the characteristics of the return loss (S11) and the insertion loss (S21) of the transmission line TL₁ shown in FIG. 3 in accordance with some embodiments of the present disclosure. For illustrative purposes, the transmission line TL₁ shown in FIG. 6 is configured to distribute energy of the input signal S_{IN} to the eight array elements AE_{1,1} to AE_{1,8} (i.e. N in FIG. 3=8) in a series-fed manner. However, this is not intended to the limit the scope of the present disclosure. In some embodiments, the architecture shown in FIG. 6 can be applied to a transmission line coupled to different numbers of array elements without departing from the scope of the present disclosure. In some embodiments, the architecture shown in FIG. 6 can be used to extract the characteristics of the return loss and the insertion loss of other transmission lines shown in FIG. 3 without departing from the scope of the present disclosure.

In the present embodiment, the transmission line TL₁ shown in FIG. 3 can be modeled by a capacitor-inductor-capacitor (CLC) structure to unify the LC product (a product of equivalent inductance and equivalent capacitance) for all array elements. For example, the LC product of the array element AE_{1,i} may be determined by the transmission line segments TL1_i1, TL1_i2 and TL1_i3, along with the equivalent input circuit of the tap point TPᵢ (including the capacitor Cᵢ, and the equivalent resistor R_{Pi} and the equivalent capacitor C_{Pi} at the input terminal TIᵢ), where i=1, 2, . . . , 8. The equivalent circuit of the transmission line segment TL1_i1 includes the inductor Lᵢ₁, the capacitors C_{iA1}, and C_{iB1}; the equivalent circuit of the transmission line segment TL1_i2 includes the inductor Lᵢ₂, the capacitors C_{iA2}, and C_{iB2}; and the equivalent circuit of the transmission line segment TL1_i3 includes the inductor Lᵢ₃, the capacitors Cᵢₐ₃, and C_{iB3}. Additionally, the input end of the transmission line TL₁ may be connected to the termination element Z_{IN}, with an impedance value matched to the characteristic impedance of the transmission line TL₁; the output end of the transmission line TL₁ may be connected to the termination element Z_{OUT}, with an impedance value matched to the characteristic impedance of the transmission line TL₁.

In some embodiments, the transmission line length between adjacent tap points (or adjacent array elements) may be equal to half a wavelength of the input signal SIN propagating along the transmission line TL₁. This configuration can reduce reflection and phase interference, and improve antenna gain and overall efficiency. Additionally, in some embodiments, the LC products of the array system 300 may be maintained at a predetermined value or within a predetermined range to ensure consistency. The resonant frequency determined according to equivalent inductance and equivalent capacitance at each tap point (corresponding to the square root of the equivalent inductance and capacitance) can be higher or significantly higher than a maximum frequency within an operating frequency band of the array system 300, achieving favorable S11 and S21 characteristics.

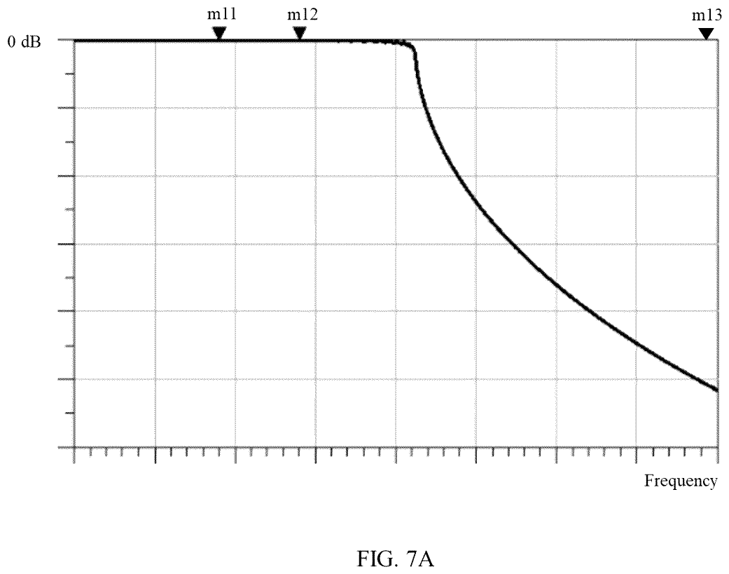

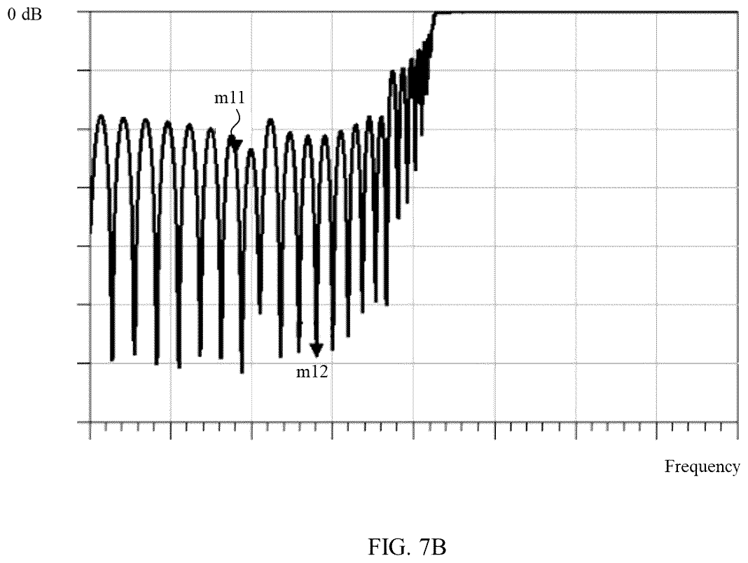

FIG. 7A illustrates frequency responses of the insertion loss (S21) for the eight-array-element series-fed system shown in FIG. 6 in accordance with some embodiments of the present disclosure. Referring to FIG. 7A, in the present embodiment, the S21 values at the operating frequencies m11 and m12 are close to or equal to 0 dB, indicating quite small insertion loss. The resonant frequency determined according to the LC product can be designed to be a high frequency m13 that is significantly outside the operating frequency band. As shown in FIG. 7A, within the operating frequency band, the LC products are consistent, allowing effective impedance matching or power distribution.

FIG. 7B illustrates frequency responses of the return loss (S11) for the eight-array-element series-fed system shown in FIG. 6 in accordance with some embodiments of the present disclosure. Referring to FIG. 7B, in the present embodiment, the local maximum S11 values within the operating frequency band maintain a substantial margin from 0 dB, indicating quite small return loss. For example, the S11 values at the operating frequencies m11 and m12 are significantly less than 0 dB, allowing the series-fed system operating at the operating frequency m11/m12 to achieve high efficient signal transmission.

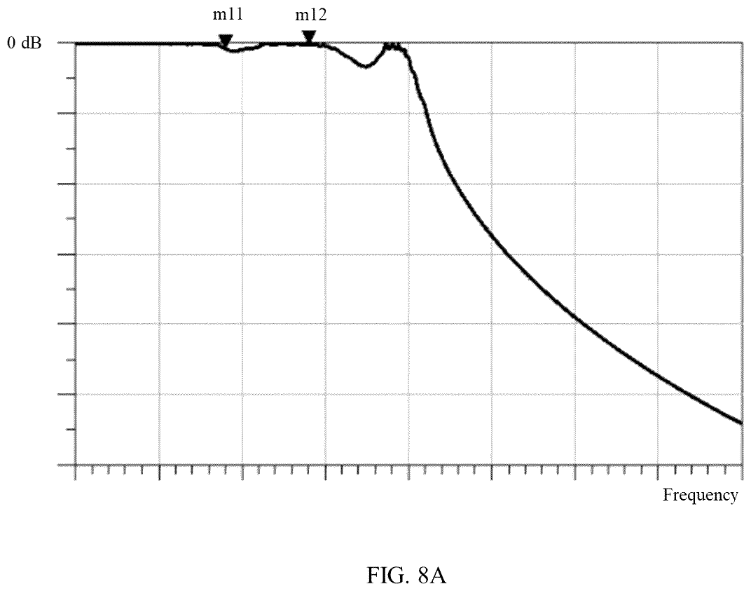

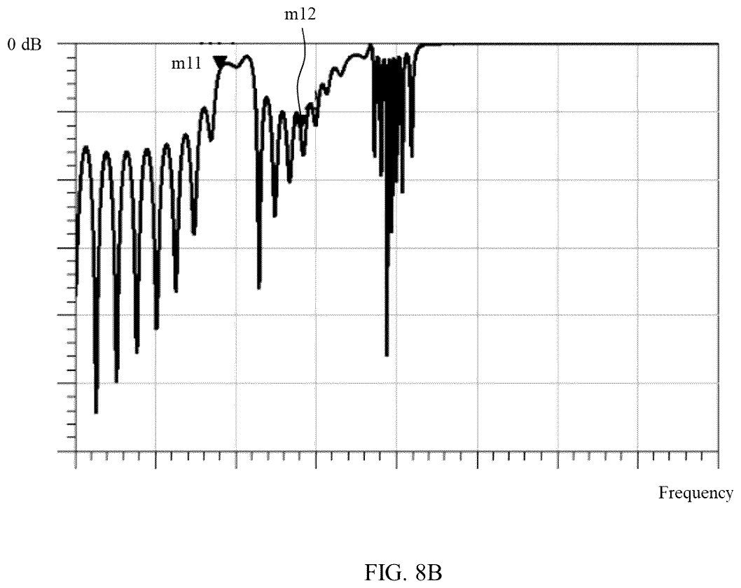

Note that in some cases where tap points of a transmission line are directly connected to respective input terminals of array elements, frequency responses of the insertion loss and the return loss will be impacted by input capacitance variations of the array elements. For example, referring to FIG. 8A, the frequency response of the insertion loss (S21) is illustrated in a configuration where the tap points TP₁ to TP₈ shown in FIG. 6 are directly connected to the input terminals TI₁ to TI₈, respectively, in accordance with some embodiments. As shown in FIG. 8A, S21 values exhibit inconsistency around the operating frequencies m11 and m12 due to variations in input capacitance (i.e. input capacitance at a transistor's gate), indicating inconsistent LC products within the operating frequency band. This configuration results in reduced transmission efficiency across the operating frequency band.

Additionally, referring to FIG. 8B, the frequency response of the return loss (S11) is illustrated in a configuration where the tap points TP₁ to TP₈ shown in FIG. 6 are directly connected to the input terminals TI₁ to TI₈, respectively, in accordance with some embodiments. As shown in FIG. 8B, the S11 values exhibit a large variation within the operating frequency band, and some of them even approach 0 dB. For example, the S11 values at the operating frequencies m11 and m12 are higher than the maximum S11 value within the operating frequency band in FIG. 7B, indicating relatively poor transmission efficiency.

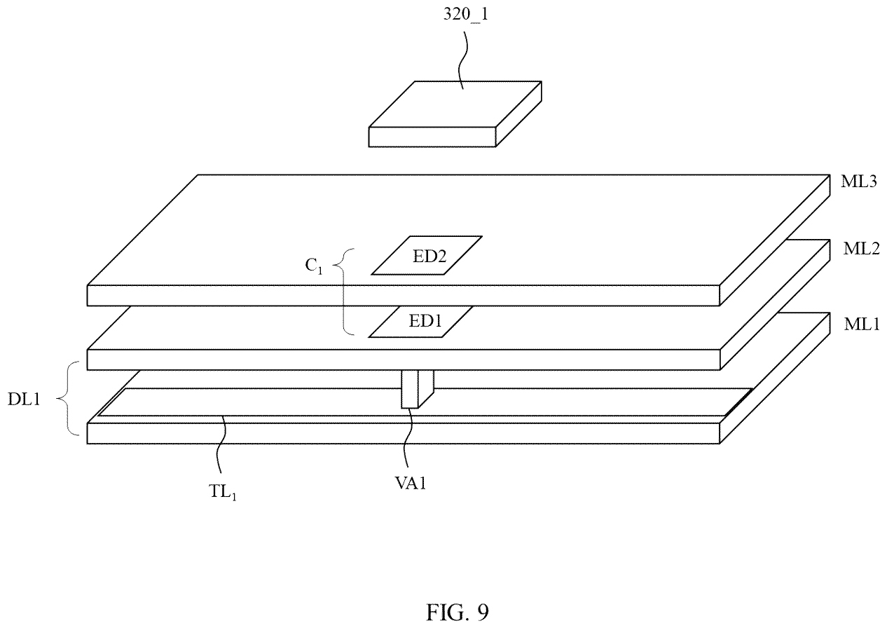

FIG. 9 is a diagram illustrating an implementation of the capacitor C₁ in the high-impedance feed path shown in FIG. 3 in accordance with some embodiments of the present disclosure. Note that the structure shown in FIG. 9 can be used to implement other capacitors in high-impedance feed paths shown in FIG. 3 without departing from the scope of the present disclosure.

In the present embodiment, the transmission line TL₁ can be formed in the metal layer ML1; the capacitor C₁ has electrodes ED1 and ED2, which can are formed in the metal layers ML2 and ML3 respectively. The metal layer ML2 is located between the metal layers ML1 and ML3. In some examples, the transmission line TL₁ and the capacitor C₁ may be integrated using a thin-film process; the capacitor C₁ may be a thin-film capacitor with stable capacitance that is significantly smaller than input capacitance of an array element (i.e. input capacitance of the array element AE_{1,1} shown in FIG. 3). By way of example but not limitation, the capacitance of the capacitor C₁ may be 0.01 pF, which is significantly smaller than input capacitance of a transistor's gate (i.e. input capacitance of a gate of the transistor M₁ shown in FIG. 3).

In addition, the conductive via VA1, penetrating through the dielectric layer DL1 between the metal layers ML1 and ML2, is arranged to electrically connect the transmission line TL₁ to the electrode ED1. The integrated circuit 320_1 (e.g. a chip) above the metal layer ML3 may be coupled to the electrode ED2 via one or more metal interconnect layers (not shown), wire bonding (not shown), or other electrical connection methods.

The structure shown in FIG. 9 is provided for illustrative purposes, and is not intended to limit the scope of the present disclosure. The capacitor in the feed path between the tap points of the transmission line and the array elements may be implemented with other semiconductor structures or processes without departing from the scope of this disclosure.

With the use a capacitor disposed in the feed path between the tap point of the transmission line and the high-input-impedance array element, the proposed series-fed array system can reduce or eliminate the effect of temperature or environmental variations on the input capacitance of the array element, achieving effective impedance matching design and high-quality signal transmission.

As used herein, the terms “substantially” are used to describe and account for small variations. When used in conduction with an event or circumstance, the terms can refer to instances in which the event of circumstance occurs precisely as well as instances in which the event or circumstance occurs to a close approximation. As used herein with respect to ta given value or range, the term “substantially” generally means within ±10%, ±5%, ±1%, or ±0.5% of the given value or range. Ranges can be expressed herein as from one endpoint to another endpoint or between two endpoints. All ranges disclosed herein are inclusive of the endpoints, unless specified otherwise. In addition, when referring to numerical values or characteristics as “substantially” the same, the term can refer to the values lying within ±10%, ±5%, ±1%, or ±0.5% of an average of the values.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An array system for signal transmission, comprising:
a transmission line, comprising N tap points;
N array elements, configured to be driven by N voltage signals fed to N input terminals of the N array elements respectively, wherein each array element comprises a transistor, and N gates of N transistors in the N array elements serves as the N input terminals respectively; and
N capacitors, arranged to capacitively couple the N tap points to the N gates of the N transistors, respectively, to provide the N voltage signals, wherein capacitance of each capacitor is less than input capacitance at a gate of a corresponding transistor coupled to the capacitor.

2. The array system of claim 1, wherein the capacitance of the capacitor is less than one-fifth of the input capacitance at the gate of the transistor coupled to the capacitor.

3. The array system of claim 1, wherein a transmission line length between adjacent tap points is equal to half of a wavelength of an input signal propagating along the transmission line.

4. The array system of claim 1, wherein a product of equivalent inductance and equivalent capacitance at each tap point is uniform across the N tap points.

5. The array system of claim 1, wherein a resonant frequency, determined according to equivalent inductance and equivalent capacitance at each tap point, is higher than a maximum frequency within an operating frequency band of the array system.

6. The array system of claim 1, wherein the array element comprises an integrated circuit and a radiating element, the transistor is included in the integrated circuit, and the integrated circuit is driven by a corresponding voltage signal to enable the radiating element to emit a radio frequency signal.

7. The array system of claim 1, wherein respective voltage magnitudes at adjacent tap points are equal.

8. The array system of claim 1, wherein input impedance viewed from each tap point toward a corresponding capacitor coupled to the tap point is greater than characteristic impedance of the transmission line.

9. The array system of claim 1, wherein the transmission line is formed in a first metal layer; the capacitor is a thin film capacitor having a first electrode formed in a second metal layer and a second electrode formed in a third metal layer; the second metal layer is located between the first metal layer and the third metal layer.

10. The array system of claim 1, further comprising:
a first termination element, connected to an input end of the transmission line; and
a second termination element, connected to an output end of the transmission line, wherein impedance of each of the first termination element and the second termination element matches characteristic impedance of the transmission line.

11. An array system for signal transmission, comprising:
a transmission line, comprising N tap points;
N array elements, configured to be driven by N voltage signals fed to N input terminals of the N array elements respectively, each array element comprising:
a radiating element; and
an integrated circuit, coupled to the radiating element, the integrated circuit being configured to be driven by a corresponding voltage signal to enable the radiating element to emit a radio frequency signal, wherein a gate of a transistor in the integrated circuit serves as the input terminal of the array element; and
N capacitors, having N first terminals respectively coupled to the N tap points, and N second terminals respectively coupled to the N input terminals, the N capacitor being arranged to provide the N voltage signals.

12. The array system of claim 11, wherein capacitance of each capacitor is less than input capacitance at a gate of a corresponding transistor coupled to the capacitor.

13. The array system of claim 12, wherein the capacitance of the capacitor is less than one-fifth of the input capacitance.

14. The array system of claim 11, wherein a transmission line length between adjacent tap points is equal to half of a wavelength of an input signal propagating along the transmission line.

15. The array system of claim 11, wherein a product of equivalent inductance and equivalent capacitance at each tap point is uniform across the N tap points.

16. The array system of claim 11, wherein a resonant frequency, determined according to equivalent inductance and equivalent capacitance at each tap point, is higher than a maximum frequency within an operating frequency band of the array system.

17. The array system of claim 11, wherein respective voltage magnitudes at adjacent tap points are equal.

18. The array system of claim 11, wherein input impedance viewed from each tap point toward a corresponding capacitor coupled to the tap point is greater than characteristic impedance of the transmission line.

19. The array system of claim 11, wherein the transmission line is formed in a first metal layer; each capacitor is a thin film capacitor having a first electrode formed in a second metal layer and a second electrode formed in a third metal layer; the second metal layer is located between the first metal layer and the third metal layer.

20. The array system of claim 11, further comprising:
a first termination element, connected to an input end of the transmission line; and
a second termination element, connected to an output end of the transmission line, wherein impedance of each of the first termination element and the second termination element matches characteristic impedance of the transmission line.
